(19) United States
(12) Patent Application Publication
(10) Pub. No.: US 2026/0126689 A1
(43) Pub. Date: May 7, 2026

(54) DISPLAY DEVICE

(71) Applicant: InnoLux Corporation, Miao-Li County (TW)

(72) Inventors: Yu-Chih TSENG, Miao-Li County (TW); Hong-Sheng HSIEH, Miao-Li County (TW); Chu-Hong LAI, Miao-Li County (TW); Hsu-Kuan HSU, Miao-Li County (TW)

(21) Appl. No.: 19/350,358

(22) Filed: Oct. 6, 2025

(30) Foreign Application Priority Data
Nov. 5, 2024 (CN) 202411567053.1

(51) Int. Cl. G02F 1/1343; G02F 1/13; G02F 1/1337

(52) U.S. Cl. CPC G02F 1/134318; G02F 1/1323; G02F 1/1337; G02F 2201/123

(57) ABSTRACT

A display device includes a backlight module, a light adjustment unit disposed on the backlight module, and a display unit disposed on the light adjustment unit, The light adjustment unit includes a first substrate, a second substrate disposed corresponding to the first substrate, a liquid crystal layer disposed between the first substrate and the second substrate, and a first electrode layer disposed between the first substrate and the liquid crystal layer and including multiple first patterns. Each first pattern has a first width, and two adjacent first patterns of the multiple first patterns have a first distance. A ratio of the first width to the first distance is greater than or equal to 0.5 and smaller than or equal to 7.5, and a phase retardation of the liquid crystal layer is greater than or equal to 500 nm and smaller than or equal to 2700 nm.

### CROSS-REFERENCE TO RELATED APPLICATIONS

This application claims the benefits of the Chinese Patent Application Serial Number 202411567053.1, filed on November 5, 2024, the subject matter of which is incorporated herein by reference.

### BACKGROUND

### Field of the Disclosure

The present disclosure relates to a display device and, more particularly, to a display device with an anti-peeping effect.

### Description of Related Art

With the continuous development of science and technology, display devices are moving towards anti-peeping, low-power, high-quality or low-cost designs. Nowadays, most methods are to attach a privacy film to the display device or use a collimated backlight module to obtain a display device with a more concentrated light source so as to achieve a privacy effect. However, the above methods still have disadvantages such as high energy consumption, high cost or low yield.

Therefore, there is a need to provide an improved display device to alleviate and/or obviate the above defects.

### SUMMARY

The present disclosure provides a display device, which includes: a backlight module; a light adjustment unit disposed on the backlight module and including: a first substrate; a second substrate disposed corresponding to the first substrate; a liquid crystal layer disposed between the first substrate and the second substrate; and a first electrode layer disposed between the first substrate and the liquid crystal layer, and including a plurality of first patterns; and a display unit disposed on the light adjustment unit, wherein each of the plurality of first patterns has a first width, two adjacent first patterns of the plurality of first patterns have a first distance, a ratio of the first width to the first distance is greater than or equal to 0.5 and smaller than or equal to 7.5, and a phase retardation of the liquid crystal layer is greater than or equal to 500 nm and smaller than or equal to 2700 nm.

Other novel features of the disclosure will become more apparent from the following detailed description when taken in conjunction with the accompanying drawings.

### BRIEF DESCRIPTION OF DRAWINGS

FIG. 1 is a perspective schematic diagram of a display device according to an embodiment of the present disclosure;

FIG. 2 is a perspective schematic diagram of a light adjustment unit according to an embodiment of the present disclosure;

FIG. 3 is a cross-sectional diagram of a light adjustment unit according to an embodiment of the present disclosure;

FIG. 4 is a graph showing the ratio of the first width to the first distance of the electrodes at different first spacings versus the ratio of the brightness at an angle of 45 degrees to the brightness at an angle of 0 degrees when the light adjustment unit of one embodiment of the present disclosure is in a sharing mode;

FIG. 5 is a graph showing the ratio of the first width to the first distance of the electrode under different phase retardations versus the ratio of the brightness at an angle of 45 degrees to the brightness at an angle of 0 degrees when the light adjustment unit of one embodiment of the present disclosure is in the sharing mode,

FIG. 6 is a perspective schematic diagram of a light adjustment unit according to another embodiment of the present disclosure;

FIG. 7 is a cross-sectional schematic diagram of a light adjustment unit according to another embodiment of the present disclosure;

FIG. 8 is a graph showing the ratio of the first width to the first distance of the electrodes at different first spacings versus the ratio of the brightness at an angle of 45 degrees to the brightness at an angle of 0 degrees when the light adjustment unit of another embodiment of the present disclosure is in a sharing mode;

FIG. 9 is a graph showing the ratio of the first width to the first distance of the electrode under different phase retardations versus the ratio of the brightness at an angle of 45 degrees to the brightness at an angle of 0 degrees when the light adjustment unit of another embodiment of the present disclosure is in the sharing mode;

FIG. 10 is a perspective schematic diagram of a light adjustment unit according to another embodiment of the present disclosure; and

FIG. 11 is a perspective schematic diagram of a light adjustment unit according to another embodiment of the present disclosure.

### DETAILED DESCRIPTION OF EMBODIMENT

The electronic device according to the embodiment of the present disclosure is described in detail below. It should be understood that the following description provides many different embodiments for implementing different aspects of some embodiments of the present disclosure. The specific components and arrangements described below are only for the purpose of simply and clearly describing some embodiments of the present disclosure. Of course, these are only examples and are not limitations of the present disclosure. In addition, similar and/or corresponding reference numerals may be used in different embodiments to identify similar and/or corresponding components in order to clearly describe the present disclosure. However, the use of these similar and/or corresponding reference numerals is only for simply and clearly describing some embodiments of the present disclosure, and does not represent any relationship between the different embodiments and/or structures discussed.

The embodiments of the present disclosure may be understood together with the drawings, and the drawings of the present disclosure are also regarded as part of the disclosure description. It should be understood that the drawings of the present disclosure are not in scale and, in fact, the dimensions of elements may be arbitrarily enlarged or reduced in order to clearly illustrate features of the present disclosure. In addition, directional terms mentioned in the specification, such as “up”, “down”, “front”, “rear”, “left”, “right”, etc., only refer to the directions of the drawings. Accordingly, the directional term used is illustrative, not limiting, of the present disclosure. In the drawings, various figures illustrate the general characteristics of methods, structures and/or materials used in particular embodiments. However, these drawings should not be construed to define or limit the scope or nature encompassed by these embodiments. For example, the relative sizes, thicknesses and positions of various layers, regions and/or structures may be reduced or enlarged for clarity.

One structure (or layer, component, substrate) described in the present disclosure is disposed on/above another structure (or layer, component, substrate), which can mean that the two structures are adjacent and directly connected, or can refer to two structures that are adjacent rather than directly connected. Indirect connection means that there is at least one intermediate structure (or intermediate layer, intermediate component, intermediate substrate, intermediate space) between the two structures, the lower surface of one structure is adjacent to or directly connected to the upper surface of the intermediate structure, and the upper surface of the other structure is adjacent to or directly connected to the lower surface of the intermediate structure. The intermediate structure may be a single-layer or multi-layer physical structure or a non-physical structure, which is not limited. In the present disclosure, when a certain structure is arranged "on" other structures, it may mean that a certain structure is "directly" on other structures, or it means that a certain structure is "indirectly" on other structures; that is, at least one structure is sandwiched, in between a certain structure and other structures.

In addition, it should be understood that, unless otherwise specified, the ordinal numbers used in the specification and claims, such as “first” and “second”, are intended to distinguish elements rather than disclose explicitly or implicitly that names of the elements bear the wording of the ordinal numbers. The ordinal numbers do not imply what order an element and another element are in terms of space, time or steps of a manufacturing method. Thus, what is referred to as a "first element" in the specification may be referred to as a "second element" in the claims.

In some embodiments of the present disclosure, terms such as “connection” and “interconnection” about joining and connecting, unless otherwise specified, may mean that two structures are in direct contact, or may also mean that two structures are not in direct contact, where other structures are placed between the two structures. Moreover, the terms about joining and connecting may also include the situation that both structures are movable, or both structures are fixed. In addition, the term “electrical connection” or “coupling” includes any direct and indirect means of electrical connection.

In the description, the terms “almost”, “about”, “approximately” or “substantially” usually means within 10%, 5%, 3%, 2%, 1% or 0.5% of a given value or range. Unless otherwise defined, the term “range between the first value and the second value” indicates that the range includes the first value, the second value, and other values in between. Moreover, any two values or directions used for comparison may have certain errors. If the first value is equal to the second value, it implies that there may be an error of about 10% between the first value and the second value; if the first direction is perpendicular or “approximately” perpendicular to the second direction, the angle between the first direction and the second direction may be between 80 degrees and 100 degrees; if the first direction is parallel or “substantially” parallel to the second direction, the angle between the first direction and the second direction may be between 0 degrees and 10 degrees. In the present disclosure, the expressions “the given range is from the first value to the second value” and “the given range falls within the range from the first value to the second value” indicate that the given range includes the first value, the second value, and other values in between.

Furthermore, according to the embodiments of the present disclosure, an optical microscope (OM), a scanning electron microscope (SEM), an thin film thickness profiler (α-step), an ellipsometer, or other suitable methods may be used to measure the thickness, length, width of each component or the distance and angle between components. In detail, according to some embodiments, a scanning electron microscope may be used to obtain a cross-sectional image of a structure and measure the thickness, length, width of each component or the distance and angle between components.

In the entire specification and appended claims of the present disclosure, certain words are used to refer to specific components. Those skilled in the art should understand that electronic device manufacturers may refer to the same components by different names. The present disclosure does not intend to distinguish those components with the same function but different names. In the following description and claims, words such as "comprising", "including", and "having" are open type words, so they should be interpreted as meaning "including but not limited to". Therefore, when the terms "comprising", "including" and/or "having" are used in the description of the present disclosure, they specify the existence of corresponding features, regions, steps, operations and/or components, but do not exclude the existence of one or more corresponding features, regions, steps, operations and/or components.

It should be understood that, without departing from the spirit of the present disclosure, in the following embodiments, the features in different embodiments may be replaced, reorganized or mixed to accomplish other embodiments. The features among various embodiments may be mixed and matched arbitrarily as long as they do not violate the spirit of the invention or conflict with each other.

Unless otherwise defined, all terms (including technical and scientific terms) used herein have the same meaning as commonly understood by one of ordinary skill in the art to which this disclosure belongs. It may be understood that these terms, such as those defined in commonly used dictionaries, should be interpreted as having meanings consistent with the background or context of the related technology and the present disclosure, and should not be interpreted in an idealized or overly formal manner, unless otherwise specified in the embodiments of the present disclosure. The present disclosure may be understood by referring to the following detailed description in conjunction with the accompanying drawings. It should be noted that, in order to facilitate the understanding of the readers and for the simplicity of the drawings, the multiple drawings in the present disclosure only depict a portion of the electronic device, and the specific components in the drawings are not drawn according to the actual scale. In addition, the number and size of each component in the figure are only for illustration and are not intended to limit the scope of the present disclosure.

The electronic device of the present disclosure may include electronic components. Electronic components may include passive components, active components, or a combination thereof, such as capacitors, resistors, inductors, varactor diodes, variable capacitors, filters, diodes, transistors, sensors, micro-electromechanical system (MEMS) components, liquid crystal chips, etc., but not limited thereto. The diodes may include light emitting diodes or non-light emitting diodes. The diode includes a P-N junction diode, a PIN diode or a constant current diode. The light emitting diode may include, for example, an organic light emitting diode (OLED), a mini LED, a micro LED, a quantum dot LED, fluorescence, phosphor or other suitable materials, or a combination thereof, but not limited thereto. The sensor may include, for example, capacitive sensors, optical sensors, electromagnetic sensors, fingerprint sensors (FPS), touch sensors, antennas, or pen sensors, but not limited thereto. In the following description, a display device is used as an electronic device to illustrate the present disclosure, but the present disclosure is not limited thereto.

The electronic device may include an imaging device, a bonding device, a display device, a backlight device, an antenna device, a tiled device, a touch display, a curved display, or a free shape display, but not limited thereto. The electronic device may include, for example, liquid crystal, light emitting diode, fluorescence, phosphor, other suitable display media, or a combination thereof, but not limited thereto. The display device may be a non-self-luminous display device or a self-luminous display device. The antenna device may be a liquid crystal type antenna device or a non-liquid crystal type antenna device, and the sensing device may be a sensing device that senses capacitance, light, heat energy or ultrasound, but not limited thereto. The tiled device may be, for example, a display tiled device or an antenna tiled device, but not limited thereto. It should be noted that the electronic device may be any arrangement or combination of the aforementioned, but not limited thereto. The electronic device may be a bendable or flexible electronic device. It should be noted that the electronic device may be any arrangement or combination of the aforementioned, but is not limited thereto. In addition, the shape of the electronic device may be rectangular, circular, polygonal, a shape with curved edges, or other suitable shapes. The electronic device may have a peripheral system such as a driving system, a control system, a light source system, a shelf system, etc. to support a display device, an antenna device, or a tiled device. It should be noted that the following embodiments may be implemented by replacing, reorganizing, or mixing features of several different embodiments without departing from the spirit of the present disclosure so as to implement other embodiments. The features of the various embodiments may be mixed and matched as desired as long as they do not violate the spirit of the disclosure or conflict with each other. It should be noted that the technical solutions provided in the following different embodiments may be replaced, combined or mixed with each other to form another embodiment without violating the spirit of the present disclosure.

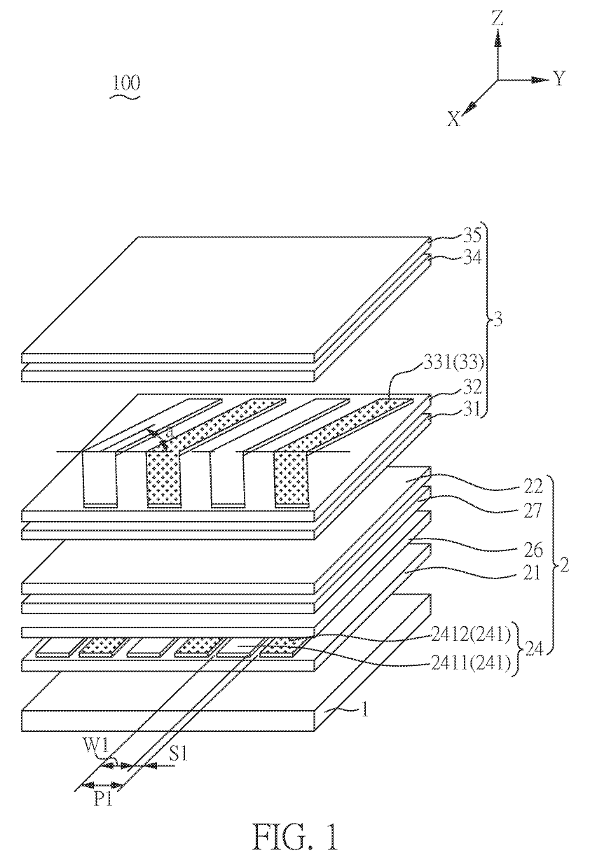

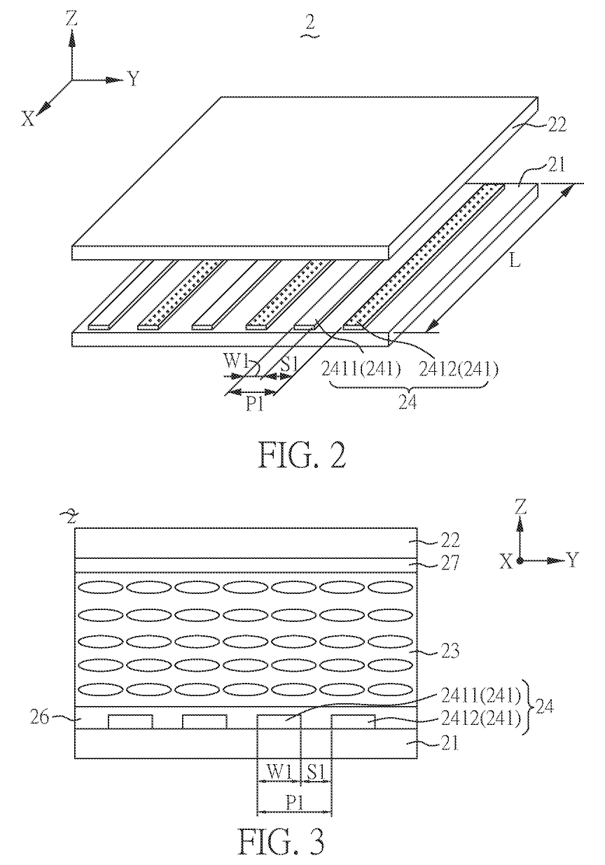

FIG. 1 is a perspective schematic diagram of a display device according to an embodiment of the present disclosure, FIG. 2 is a perspective schematic diagram of a light adjustment unit according to an embodiment of the present disclosure, and FIG. 3 is a cross-sectional diagram of a light adjustment unit according to an embodiment of the present disclosure, wherein FIG. 1 to FIG. 3 show the display area of the display device of the present disclosure, but do not show the non-display area, and for the sake of clarity, some components of FIG. 1 are not shown in FIG. 2, and the liquid crystal layer 23 of FIG. 3 is not shown in FIG. 1 to FIG. 2.

In one embodiment of the present disclosure, as shown in FIG. 1 and FIG. 3, a display device 100 includes a backlight module 1, a light adjustment unit 2, and a display unit 3. The light adjustment unit 2 is disposed on the backlight module 1, and the display unit 3 is disposed on the light adjustment unit 2. The light adjustment unit 2 includes a first substrate 21, a second substrate 22 and a liquid crystal layer 23. The second substrate 22 is disposed corresponding to the first substrate 21, and the liquid crystal layer 23 is disposed between the first substrate 21 and the second substrate 22. The light adjustment unit 2 further includes a first electrode layer 24 disposed between the first substrate 21 and the liquid crystal layer 23 and provided with a plurality of first patterns 241. Each of the plurality of first patterns 241 has a first width W1, and two adjacent first patterns 241 of the plurality of first patterns 241 have a first distance S1. The ratio of the first width W1 to the first distance S1 is greater than or equal to 0.5 and smaller than or equal to 7.5 (0.5≦W1/S1≦7.5), and the phase retardation Re of the liquid crystal layer 23 is greater than or equal to 500 nm and smaller than or equal to 2700 nm (500 nm≦Re≦2700 nm), wherein the first width W1 refers to the measure of each first pattern 241 in the second direction Y. For example, the first width W1 is the maximum measure of the first electrode 2411 and/or the second electrode 2412 in the second direction Y. In addition, the first distance S1 refers to the distance between two adjacent first patterns 241 in the second direction Y; for example, one of two adjacent first patterns 241 of the plurality of first patterns 241 is a first electrode 2411, the other one of the two adjacent first patterns 241 of the plurality of first patterns 241 is a second electrode 2412, and the first distance S1 refers to the minimum distance between the first electrode 2411 and the second electrode 2412 in the second direction Y.

In the present disclosure, the backlight module 1 may include an optical film, such as a diffuser, a prism sheet (for example, brightness enhancement film, abbreviated as BEF), a reflective brightness enhancement film (for example, dual brightness enhancement film, abbreviated as DBEF) or a viewing angle control film. The viewing angle control film may be used to control the direction of light travel, so that the display device 100 may be provided with an anti-peeping direction, thereby achieving a privacy effect. The backlight module 1 may provide, for example, a concentrated or collimated light pattern, but it is not limited thereto.

In addition, as shown in FIG. 1 to FIG. 3, in the present disclosure, the liquid crystals in the liquid crystal layer 23 adjacent to the first substrate 21 are in horizontal alignment, and the liquid crystals in the liquid crystal layer 23 adjacent to the second substrate 22 are in horizontal alignment. The liquid crystal layer 23 of the light adjustment unit 2 is driven by the electric field generated by the voltage applied between the plurality of first patterns 241 of the first electrode layer 24 to change the state thereof (the angle of rotation of the liquid crystal), thereby switching the display device 100 between the sharing mode and the privacy mode. Each first pattern 241 of the light adjustment unit 2 of the present disclosure has a length direction L, which is substantially parallel to the first direction X, and the anti-peeping direction is substantially perpendicular to the length directions L of the first patterns 241 (that is, the anti-peeping direction is parallel to the second direction Y). In the present disclosure, the plurality of first patterns 241 may each have a rectangular shape, but the present disclosure is not limited thereto. As long as the length direction L of the first pattern 241 is substantially parallel to the first direction X, the anti-peeping effect may be achieved.

In the present disclosure, as shown in FIG. 1 and FIG. 2, one of two adjacent first patterns 241 among the plurality of first patterns 241 is a first electrode 2411, and the other one of the two adjacent first patterns 241 among the plurality of first patterns 241 is a second electrode 2412, and the first electrode 2411 is different from the second electrode 2412. In more detail, the voltage of the first electrode 2411 may be different from the voltage of the second electrode 2412. For example, one of the first electrode 2411 and the second electrode 2412 is a pixel electrode, and the other one is a common electrode, but the present disclosure is not limited thereto.

Next, as shown in FIG. 1 to FIG. 3, the light adjustment unit 2 may include a first alignment film 26, which is arranged between the first substrate 21 and the liquid crystal layer 23, wherein the first alignment film 26 has a first rubbing direction (not shown), one of the plurality of first patterns 241 has a length direction L, and the first rubbing direction is perpendicular to the length direction L (for example, the included angle of the two is between 80^{o} and 100^{o}) or parallel to the length direction L (for example, the included angle of the two is between 0^{o} and 10^{o}). The light adjustment unit 2 may further include a second alignment film 27, and the second alignment film 27 is disposed between the second substrate 22 and the liquid crystal layer 23, wherein the second alignment film 27 has a second rubbing direction (not shown). In some embodiments, the first rubbing direction is substantially parallel to the second rubbing direction, wherein the first rubbing direction and the second rubbing direction refer to the directions of mechanical rubbing or the directions of photolithography formation on the first alignment film 26 and the second alignment film 27, so as to achieve the effect of liquid crystal alignment.

In the present disclosure, as shown in FIG. 1, the display unit 3 includes a first polarizer 31, a third substrate 32, a third electrode layer 33, a fourth substrate 34 and a second polarizer 35. The third substrate 32 is disposed on the first polarizer 31, and the second polarizer 35 is disposed on the fourth substrate 34. The fourth substrate 34 is disposed opposite to the third substrate 32. The third electrode layer 33 is disposed between the third substrate 32 and the fourth substrate 34, and has a plurality of third patterns 331, wherein an angle “a” is formed between one of the third patterns 331 and the second direction Y, and the angle “a” is an acute angle smaller than 90 degrees. Although not shown, the display unit 3 may include a display medium layer (for example, a liquid crystal layer) disposed between the third substrate 32 and the fourth substrate 34. In addition, although not shown, the display unit 3 may further include: an alignment layer disposed between the third electrode layer 33 and the display medium layer, and another alignment layer disposed between the fourth substrate 34 and the display medium layer. The type of the display unit 3 may be, for example, a suitable type such as fringe field switching (FFS), in-plane switching (IPS), etc.

In the present disclosure, the first substrate 21, the second substrate 22, the third substrate 32 and/or the fourth substrate 34 may include a rigid substrate, a soft substrate or a flexible substrate. The materials of the first substrate 21, the second substrate 22, the third substrate 32 and/or the fourth substrate 34 may be the same or different from each other. The materials of the first substrate 21, the second substrate 22, the third substrate 32 and/or the fourth substrate 34 may each include glass, quartz, sapphire, ceramic, plastic, polycarbonate (PC), polyimide (PI), polypropylene (PP), polyethylene terephthalate (PET), polymethylmethacrylate (PMMA), other suitable materials or a combination thereof, but the present disclosure is not limited thereto. When the first substrate 21, the second substrate 22, the third substrate 32 and/or the fourth substrate 34 are flexible substrates, the display device 100 of the present disclosure may be a flexible display device.

In the present disclosure, although not shown, active components (for example, transistors), wires (not shown), insulating layers (not shown), or a combination thereof may be disposed on the first substrate 21, the second substrate 22, the third substrate 32, and/or the fourth substrate 34, but the present disclosure is not limited thereto.

In the present disclosure, the materials of the first electrode layer 24 and/or the third electrode layer 33 may be the same or different from each other. The materials of the first electrode layer 24 and/or the third electrode layer 33 may each include a transparent conductive material, such as indium zinc oxide (IZO), indium tin oxide (ITO), indium tin zinc oxide (ITZO), indium gallium zinc oxide (IGZO), aluminum zinc oxide (AZO) or a combination thereof, but the present disclosure is not limited thereto.

The display device 100 of the present disclosure may light up the backlight in the backlight module 1, wherein the backlight may be, for example, a concentrated light pattern. When voltage is applied to the light adjustment unit 2, the light pattern will be scattered, which may achieve the effect of light diffusion, so that the display device 100 presents a sharing mode. On the contrary, when no voltage is applied to the light adjustment unit 2, the light pattern is concentrated, which may achieve an anti-peeping effect, so that the display device 100 presents a privacy mode to provide a privacy effect. By switching the light adjustment unit 2 to be applied with voltage and not applied with voltage, the display device 100 of the present disclosure may be switched between a sharing mode and a privacy mode, thereby achieving switchable anti-peeping requirements.

In the display device 100 capable of switching between privacy mode and sharing mode, in addition to having good anti-peeping performance in the privacy mode, it must also have good light diffusion performance in the sharing mode. FIG. 4 is a graph showing the ratio of the first width to the first distance of the electrodes at different first spacings versus the ratio of the brightness at an angle of 45 degrees to the brightness at an angle of 0 degrees when the light adjustment unit of one embodiment of the present disclosure is in a sharing mode, wherein L45 is the brightness at an angle of 45 degrees and L0 is the brightness at an angle of 0 degrees. As shown in FIG. 1 and FIG. 4, the light scattering performance of different first spacings P1 in the sharing mode is described under the condition that the liquid crystal layer 23 has the same phase retardation Re (for example, the phase retardation Re is 2160 nm). Taking into account the process conditions, reducing the signal interference of the plurality of first patterns 241 in the same layer, and/or in the privacy mode with a specific anti-peeping effect, the first spacing P1 between the plurality of first patterns 241 may be between 6 µm and 12 µm (6 µm≦P1≦12 µm) to ensure that the display device 100 has a good light scattering effect, wherein the first spacing P1 is preferred to be, for example, 8 µm to 10 µm (8 µm≦P1≦10 µm), about 8 µm, about 9 µm or about 10 µm, and the first spacing P1 refers to the sum of the first width W1 and the first distance S1 (that is, P1=W1+S1). In some embodiments, the first spacing P1 refers to the distance between the edges of two adjacent first patterns 241 on the same side. For example, the two adjacent first patterns 241 are the first electrode 2411 and the second electrode 2412. The first spacing P1 is the distance from the left edge of the first electrode 2411 to the left edge of the second electrode 2412.

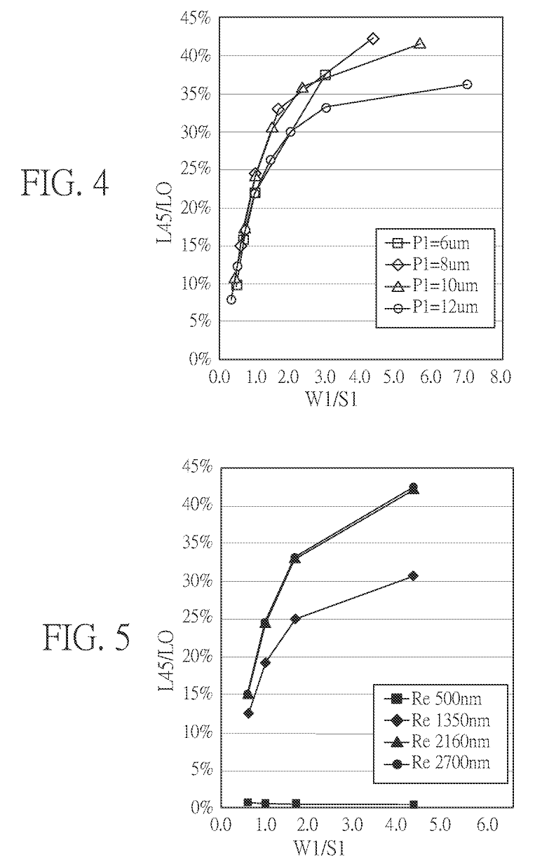

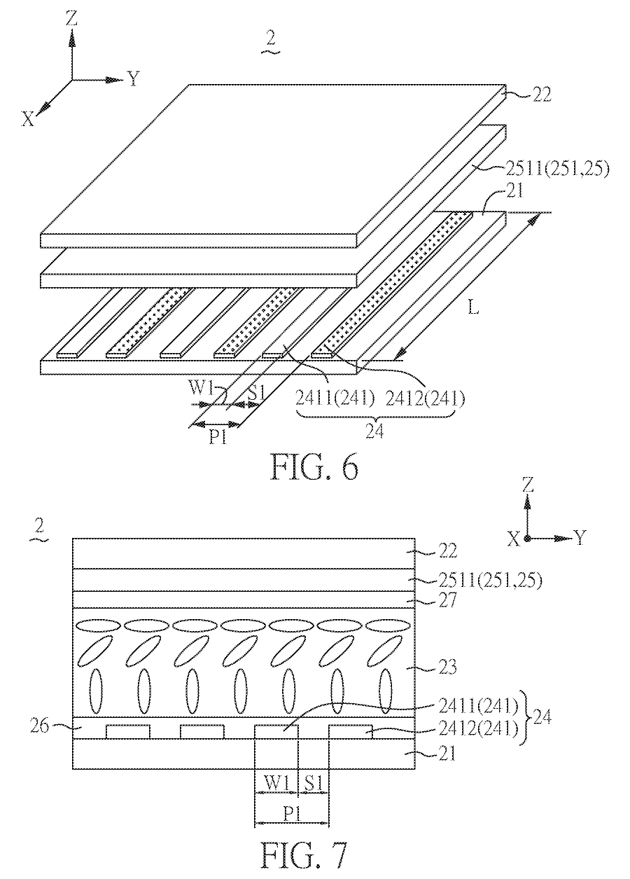

FIG. 5 is a graph showing the ratio of the first width to the first distance of the electrode under different phase retardations versus the ratio of the brightness at an angle of 45 degrees to the brightness at an angle of 0 degrees when the light adjustment unit of one embodiment of the present disclosure is in the sharing mode, wherein L45 is the brightness at an angle of 45 degrees and L0 is the brightness at an angle of 0 degrees. As shown in FIG. 1 and FIG. 3 to FIG. 5, under the condition of the same first spacing P1 (for example, the first spacing P1 is 8 μm), when the phase retardation Re of the liquid crystal layer 23 is smaller than 500 nm, the light scattering effect of the light adjustment unit 2 is not satisfactory, and when the phase retardation Re of the liquid crystal layer 23 is greater than 2700 nm, the light scattering effect is not significantly improved, while the material cost and the manufacturing process of the liquid crystal layer 23 are greatly increased, resulting in poor efficiency. Therefore, the phase retardation Re of the liquid crystal layer 23 may be greater than or equal to 500 nm and smaller than or equal to 2700 nm (500 nm≦Re≦2700 nm), for example, greater than or equal to 700 nm and smaller than or equal to 2500 nm (700 nm≦Re≦2500 nm), greater than or equal to 900 nm and smaller than or equal to 2300 nm (900 nm≦Re≦2300 nm), or greater than or equal to 1100 nm and smaller than or equal to 2200 nm (1100 nm≦Re≦2200 nm).

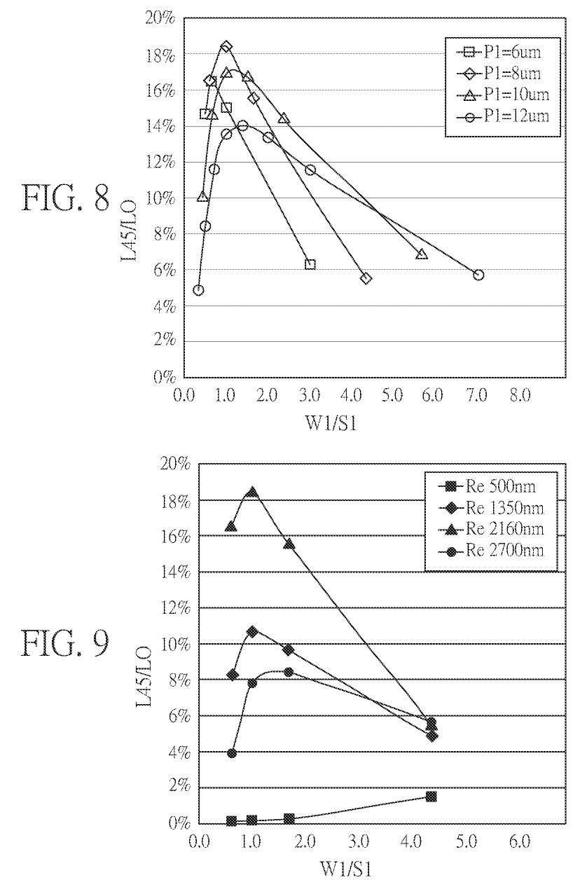

FIG. 6 is a perspective schematic diagram of a light adjustment unit according to another embodiment of the present disclosure, FIG. 7 is a cross-sectional schematic diagram of a light adjustment unit according to another embodiment of the present disclosure, and please refer to FIG. 1 to FIG. 3 at the same time, wherein some features of the embodiment of FIG. 6 and FIG. 7 are applicable to the description of the embodiments of FIG. 1 to FIG. 3 and thus a detailed description is deemed unnecessary, and the following description mainly focuses on the differences. Compared to the embodiment of FIG. 1 to FIG. 3, the light adjustment unit 2 of the embodiment of FIG. 6 and FIG. 7 further includes a second electrode layer 25, which is arranged between the second substrate 22 and the liquid crystal layer 23, wherein the second electrode layer 25 includes a second pattern 251, and the second pattern 251 overlaps with a plurality of first patterns 241, and wherein the second pattern 251 is a third electrode 2511, and the voltage of the third electrode 2511 is between the voltage of the first electrode 2411 and the voltage of the second electrode 2412. The first electrode 2411 and the second electrode 2412 may be, for example, pixel electrodes with two different voltages, and the third electrode 2511 may be, for example, a common electrode, but it is not limited thereto. In some embodiments, the material of the first electrode layer 24 may be different from the material of the second electrode layer 25.

In addition, the voltage difference between the first electrode 2411 and the third electrode 2511 is equal to the voltage difference between the second electrode 2412 and the third electrode 2511. For example, the voltage of the first electrode 2411 is 5V, the voltage of the second electrode 2412 is -5V and the voltage of the third electrode 2511 is 0V, or the voltage of the first electrode 2411 is 12V, the voltage of the second electrode 2412 is 2V and the voltage of the third electrode 2511 is 7V, but the present disclosure is not limited thereto. Here, the voltage relationship among the first electrode 2411, the second electrode 2412 and the third electrode 2511 is a relative concept.

In the present disclosure, the second electrode layer 25 is a full-planar electrode, and its material may include a transparent conductive material, such as indium zinc oxide (IZO), indium tin oxide (ITO), indium tin zinc oxide (ITZO), indium gallium zinc oxide (IGZO), aluminum zinc oxide (AZO) or a combination thereof, but the present disclosure is not limited thereto.

In the present disclosure, the light adjustment unit 2 may further include a first alignment film 26, which is arranged between the first substrate 21 and the liquid crystal layer 23, wherein the first alignment film 26 has a first rubbing direction (not shown), one of the plurality of first patterns 241 has a length direction L, and the first rubbing direction is perpendicular to the length direction L (for example, the included angle of the two is between 80^{o} and 100^{o}) or parallel to the length direction L (for example, the included angle of the two is between 0^{o} and 10^{o}). Here, the first rubbing direction refers to the direction of mechanical rubbing or the direction of photolithography formation on the first alignment film 26, so as to achieve the effect of liquid crystal alignment. In addition, the light adjustment unit 2 may further include a second alignment film 27 disposed between the second substrate 22 and the liquid crystal layer 23, wherein the second rubbing direction of the second alignment film 27 is substantially parallel to the first rubbing direction. Here, the formation method and effect of the second rubbing direction are similar to those of the first rubbing direction, and thus a detailed description is deemed unnecessary.

In the present disclosure, as shown in FIG. 7, the liquid crystals in the liquid crystal layer 23 adjacent to the first substrate 21 are in vertical alignment, and the liquid crystals in the liquid crystal layer 23 adjacent to the second substrate 22 are in horizontal alignment.

FIG. 8 is a graph showing the ratio of the first width to the first distance of the electrodes at different first spacings versus the ratio of the brightness at an angle of 45 degrees to the brightness at an angle of 0 degrees when the light adjustment unit of another embodiment of the present disclosure is in a sharing mode, wherein L45 is the brightness at an angle of 45 degrees and L0 is the brightness at an angle of 0 degrees. As shown in FIG. 6 to FIG. 8, the light scattering performance of different first spacings P1 in the sharing mode is described under the condition that the phase retardation Re of the liquid crystal layer 23 is the same (for example, the phase retardation Re is 2160 nm). Taking into account the process conditions, reducing the signal interference of the plurality of first patterns 241 in the same layer, and/or in the privacy mode with a specific anti-peeping effect, the first spacing P1 between the plurality of first patterns 241 may be between 6 µm and 12 µm (6 µm≦P1≦12 µm) to ensure that the display device 100 has a good light scattering effect, wherein the first spacing P1 is preferred to be, for example, 8 µm to 10 µm (8 µm≦P1≦10 µm), about 8 µm, about 9 µm or about 10 µm. Here, the description of the first spacing P1 is the same as the above description. Furthermore, in the present disclosure, the ratio of the first width W1 to the first distance S1 may be greater than or equal to 0.5 and smaller than or equal to 7.5 (0.5≦W1/S1≦7.5), for example, greater than or equal to 0.5 and smaller than or equal to 3 (0.5≦W1/S1≦3).

FIG. 9 is a graph showing the ratio of the first width to the first distance of the electrode under different phase retardations versus the ratio of the brightness at an angle of 45 degrees to the brightness at an angle of 0 degrees when the light adjustment unit of another embodiment of the present disclosure is in the sharing mode, wherein L45 is the brightness at an angle of 45 degrees and L0 is the brightness at an angle of 0 degrees. As shown in FIG. 6 to FIG. 7 and FIG. 9, under the condition of the same first spacing P1 (for example, the first spacing P1 is 8 μm), when the phase retardation Re of the liquid crystal layer 23 is smaller than 500 nm, the light scattering effect of the light adjustment unit 2 is not satisfactory, and when the phase retardation Re of the liquid crystal layer 23 is greater than 2700 nm, the light scattering effect is not significantly improved, while the material cost and process of the liquid crystal layer 23 are greatly increased, resulting in poor efficiency. Therefore, the phase retardation Re of the liquid crystal layer 23 may be greater than or equal to 500 nm and smaller than or equal to 2700 nm (500 nm≦Re≦2700 nm), for example, greater than or equal to 700 nm and smaller than or equal to 2500 nm (700 nm≦Re≦2500 nm), greater than or equal to 900 nm and smaller than or equal to 2300 nm (900 nm≦Re≦2300 nm), or greater than or equal to 1100 nm and smaller than or equal to 2200 nm (1100 nm≦Re≦2200 nm).

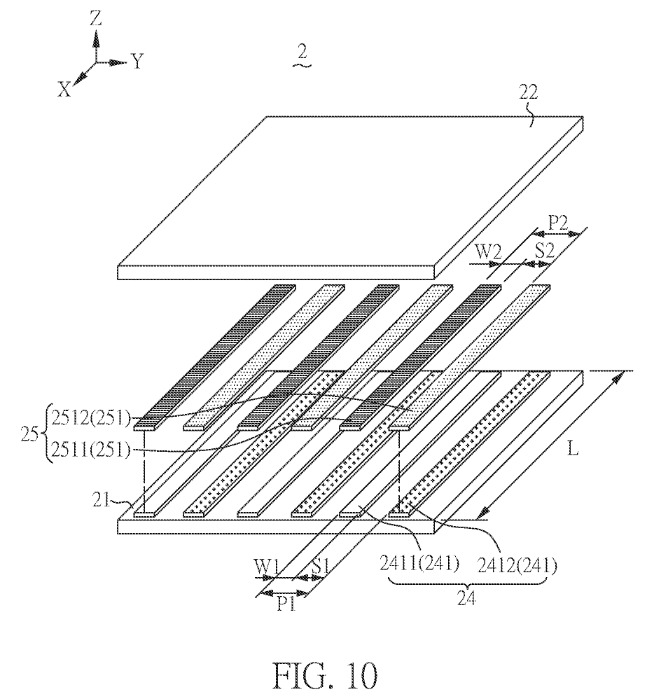

FIG. 10 is a perspective schematic diagram of a light adjustment unit according to another embodiment of the present disclosure, and please refer to FIG. 1 to FIG. 3 at the same time, wherein some features of the embodiment of FIG. 10, the ratio range of the first width W1 to the first distance S1 and the phase retardation Re range of the liquid crystal layer 23 are applicable to the description of the embodiments of FIG. 1 to FIG. 3 and thus a detailed description is deemed unnecessary ,and the following description mainly focuses on the differences. Compared to the embodiments of FIG. 1 to FIG. 3, the light adjustment unit 2 of the embodiment of FIG. 10 further includes a second electrode layer 25, which is arranged between the second substrate 22 and the liquid crystal layer 23, wherein the second electrode layer 25 includes a plurality of second patterns 251, each of the plurality of second patterns 251 has a second width W2, and two adjacent second patterns 251 of the plurality of second patterns 251 have a second distance S2. The ratio of the second width W2 to the second distance S2 is greater than or equal to 0.5 and smaller than or equal to 7.5 (0.5≦W1/S1≦7.5), and the ratio of the second spacing P2 to the first spacing P1 is greater than 0 and smaller than or equal to 2, but it is not limited thereto. In some embodiments, the first spacing P1 is equal to the second spacing P2 (in other words, the ratio of the first spacing P1 to the second spacing P2 is 1), but the present disclosure is not limited thereto. In one embodiment of the present disclosure, the first spacing P1 and the second spacing P2 are in a multiple relationship, wherein the first spacing P1 refers to the sum of the first width W1 and the first distance S1 (that is, P1=W1+S1), and the second spacing P2 refers to the sum of the second width W2 and the second distance S2 (that is, P2=W2+S2). In some embodiments, the first spacing P1 refers to the distance between the edges of two adjacent first patterns 241 on the same side, and the second spacing P2 refers to the distance between the edges of two adjacent second patterns 251 on the same side.

In the present disclosure, one of two adjacent first patterns 241 among the plurality of first patterns 241 is a first electrode 2411, the other one of the two adjacent first patterns 241 among the plurality of first patterns 241 is a second electrode 2412, and the first electrode 2411 is different from the second electrode 2412, while one of two adjacent second patterns 251 among the plurality of second patterns 251 is a third electrode 2511, the other one of the two adjacent second patterns 251 among the plurality of second patterns 251 is a fourth electrode 2512, and the third electrode 2511 is different from the fourth electrode 2512. In more detail, the voltage of the first electrode 2411 may be different from the voltage of the second electrode 2412, and the voltage of the third electrode 2511 may be different from the voltage of the fourth electrode 2512. The first electrode 2411 overlaps with the third electrode 2511, and the second electrode 2412 overlaps with the fourth electrode 2512. In some embodiments, the first electrode 2411 and the fourth electrode 2512 are the same electrode, and the second electrode 2412 and the third electrode 2511 are the same electrode. In some embodiments, one of the first electrode 2411 and the second electrode 2412 is a pixel electrode, and the other one is a common electrode, but the present disclosure is not limited thereto. In some embodiments, the material of the first electrode layer 24 may be different from the material of the second electrode layer 25.

In the present disclosure, the first electrode 2411 and the third electrode 2511 are different electrodes, and the second electrode 2412 and the fourth electrode 2512 are different electrodes. In detail, the voltage of the first electrode 2411 may be different from the voltage of the third electrode 2511, and the voltage of the second electrode 2412 may be different from the voltage of the fourth electrode 2512. In some embodiments, the voltage difference between the first electrode 2411 and the third electrode 2511 is equal to the voltage difference between the fourth electrode 2512 and the second electrode 2412. In some embodiments, the voltage of one of the first electrode 2411 and the second electrode 2412 is 0V, and the voltage of the other one is a positive voltage or a negative voltage. For example, the voltage between the first electrode 2411 and the fourth electrode 2512 is 0V, and the voltage between the second electrode 2412 and the third electrode 2511 is 5V, but the present disclosure is not limited thereto. In other embodiments, the first electrode 2411 and the third electrode 2511 are opposite electrodes, the second electrode 2412 and the fourth electrode 2512 are opposite electrodes, the first electrode 2411 and the second electrode 2412 are opposite electrodes, and the third electrode 2511 and the fourth electrode 2512 are opposite electrodes, wherein opposite electrodes refer to two electrodes having opposite electrical properties. For example, the first electrode 2411 is a positive electrode and the second electrode 2412 is a negative electrode, or the first electrode 2411 is a negative electrode and the second electrode 2412 is a positive electrode.

In the present disclosure, the liquid crystals in the liquid crystal layer 23 adjacent to the first substrate 21 are in horizontal alignment, and the liquid crystals in the liquid crystal layer 23 adjacent to the second substrate 22 are in horizontal alignment.

In the present disclosure, the material of the second electrode layer 25 may include a transparent conductive material, such as indium zinc oxide (IZO), indium tin oxide (ITO), indium tin zinc oxide (ITZO), indium gallium zinc oxide (IGZO), aluminum zinc oxide (AZO) or a combination thereof, but the present disclosure is not limited thereto.

In the present disclosure, the light adjustment unit 2 may further include a first alignment film 26 (refer to FIG. 3), which is arranged between the first substrate 21 and the liquid crystal layer 23, wherein the first alignment film 26 has a first rubbing direction (not shown), one of the plurality of first patterns 241 has a length direction L, and the first rubbing direction is perpendicular to the length direction L (for example, the included angle of the two is between 80^{o} and 100^{o}) or parallel to the length direction L (for example, the included angle of the two is between 0^{o} and 10^{o}), wherein the first rubbing direction refers to the direction of mechanical rubbing or the direction of photolithography formation on the first alignment film 26, so as to achieve the effect of liquid crystal alignment. In addition, the light adjustment unit 2 may further include a second alignment film 27 (refer to FIG. 3) disposed between the second substrate 22 and the liquid crystal layer 23, wherein the second rubbing direction of the second alignment film 27 is substantially parallel to the first rubbing direction. Here, the formation method and effect of the second rubbing direction are similar to those of the first rubbing direction, and thus a detailed description is deemed unnecessary.

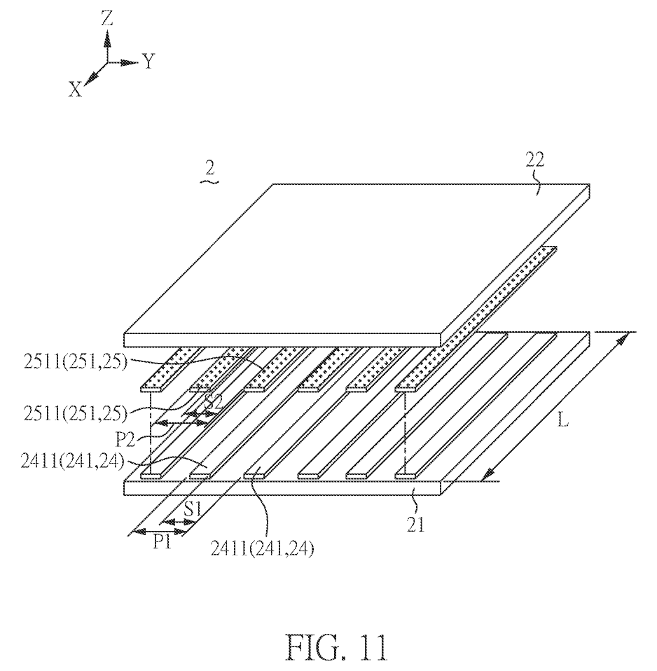

FIG. 11 is a perspective schematic diagram of a light adjustment unit according to another embodiment of the present disclosure, wherein some features of the embodiment of FIG. 11, the ratio range of the first width W1 to the first distance S1 and the phase retardation Re range of the liquid crystal layer 23 are applicable to the description of the embodiments of FIG. 1 to FIG. 3, and thus a detailed description is deemed unnecessary and the following description mainly focuses on the differences. Compared to the embodiments of FIG. 1 to FIG. 3, the light adjustment unit 2 of the embodiment of FIG. 11 further includes a second electrode layer 25, which is arranged between the second substrate 22 and the liquid crystal layer 23, wherein the second electrode layer 25 includes a plurality of second patterns 251, one of the plurality of first patterns 241 is a first electrode 2411, one of the plurality of second patterns 251 is a second electrode 2511, and the first electrode 2411 is different from the second electrode 2511. In more detail, the voltage of the first electrode 2411 may be different from the voltage of the second electrode 2511. For example, one of the first electrode 2411 and the second electrode 2511 is a pixel electrode, and the other one is a common electrode, but the present disclosure is not limited thereto. In some embodiments, the material of the first electrode layer 24 may be different from the material of the second electrode layer 25. Furthermore, in the present disclosure, the plurality of first patterns 241 and the plurality of second patterns 251 overlap each other, and the first spacing P1 is equal to the second spacing P2 (in other words, the ratio of the first spacing P1 to the second spacing P2 is 1). In some embodiments, a first width W1 of at least one of the plurality of first patterns 241 is equal to a second width W2 of at least one of the plurality of second patterns 251, but the present disclosure is not limited thereto. In some embodiments, a first distance S1 between two adjacent first patterns 241 is equal to a second distance S2 between two adjacent second patterns 251, but the present disclosure is not limited thereto. In some embodiments, the voltage of one of the first electrode 2411 and the second electrode 2511 is 0V, and the voltage of the other one is a positive voltage or a negative voltage. In some other embodiments, the first electrode 2411 and the second electrode 2511 are opposite electrodes, wherein opposite electrodes refer to two electrodes having opposite electrical properties. For example, the first electrode 2411 is a positive electrode and the second electrode 2511 is a negative electrode, or the first electrode 2411 is a negative electrode and the second electrode 2511 is a positive electrode.

In the present disclosure, the liquid crystals in the liquid crystal layer 23 adjacent to the first substrate 21 are in horizontal alignment, and the liquid crystals in the liquid crystal layer 23 adjacent to the second substrate 22 are in horizontal alignment.

In the present disclosure, the material of the second electrode layer 25 may include a transparent conductive material, such as indium zinc oxide (IZO), indium tin oxide (ITO), indium tin zinc oxide (ITZO), indium gallium zinc oxide (IGZO), aluminum zinc oxide (AZO) or a combination thereof, but the present disclosure is not limited thereto.

In the present disclosure, the light adjustment unit 2 may further include a first alignment film 26 (refer to FIG. 3), which is arranged between the first substrate 21 and the liquid crystal layer 23, wherein the first alignment film 26 has a first rubbing direction (not shown), one of the plurality of first patterns 241 has a length direction L, and the first rubbing direction is perpendicular to the length direction L (for example, the included angle of the two is between 80^{o} and 100^{o}) or parallel to the length direction L (for example, the included angle of the two is between 0^{o} and 10^{o}). Here, the first rubbing direction refers to the direction of mechanical rubbing or the direction of photolithography formation on the first alignment film 26, so as to achieve the effect of liquid crystal alignment. In addition, the light adjustment unit 2 may further include a second alignment film 27 (refer to FIG. 3) disposed between the second substrate 22 and the liquid crystal layer 23, wherein the second rubbing direction of the second alignment film 27 is substantially parallel to the first rubbing direction. Here, the formation method and effect of the second rubbing direction are similar to those of the first rubbing direction, and thus a detailed description is deemed unnecessary.

The aforementioned specific embodiments should be construed as merely illustrative, and not limiting the rest of the present disclosure in any way.

1. A display device, comprising:
a backlight module;
a light adjustment unit disposed on the backlight module and including:
a first substrate;
a second substrate disposed corresponding to the first substrate;
a liquid crystal layer disposed between the first substrate and the second substrate; and
a first electrode layer disposed between the first substrate and the liquid crystal layer, and including a plurality of first patterns; and
a display unit disposed on the light adjustment unit,
wherein each of the plurality of first patterns has a first width, two adjacent first patterns of the plurality of first patterns have a first distance, a ratio of the first width to the first distance is greater than or equal to 0.5 and smaller than or equal to 7.5, and a phase retardation of the liquid crystal layer is greater than or equal to 500 nm and smaller than or equal to 2700 nm.

2. The display device as claimed in claim 1, wherein one of two adjacent first patterns of the plurality of first patterns is a first electrode, the other one of the two adjacent first patterns of the plurality of first patterns is a second electrode, and the first electrode is different from the second electrode.

3. The display device as described in claim 2, wherein the light adjustment unit further includes a second electrode layer disposed between the second substrate and the liquid crystal layer, the second electrode layer includes a second pattern overlapping the plurality of first patterns, the second pattern is a third electrode, and a voltage of the third electrode is between a voltage of the first electrode and a voltage of the second electrode.

4. The display device as claimed in claim 2, wherein one of the first electrode and the second electrode is a pixel electrode, and the other one of the first electrode and the second electrode is a common electrode.

5. The display device as claimed in claim 2, wherein the display unit includes a third substrate, a third electrode layer, and a fourth substrate disposed opposite to the third substrate, and the third electrode layer is disposed between the third substrate and the fourth substrate and has a plurality of third patterns.

6. The display device as claimed in claim 3, wherein a voltage difference between the first electrode and the third electrode is equal to a voltage difference between the second electrode and the third electrode.

7. The display device as claimed in claim 3, wherein liquid crystals in the liquid crystal layer adjacent to the first substrate are in vertical alignment, and liquid crystals in the liquid crystal layer adjacent to the second substrate are in horizontal alignment.

8. The display device as claimed in claim 3, wherein the ratio of the first width to the first distance is greater than or equal to 0.5 and smaller than or equal to 3.

9. The display device as claimed in claim 3, wherein the first electrode and the second electrode are pixel electrodes with different voltages, and the third electrode is a common electrode.

10. The display device as claimed in claim 1, wherein the light adjustment unit further includes a second electrode layer disposed between the second substrate and the liquid crystal layer and including a plurality of second patterns, in which two adjacent first patterns of the plurality of first patterns have a first spacing, two adjacent second patterns of the plurality of second patterns have a second spacing, and a ratio of the second spacing to the first spacing is greater than 0 and smaller than or equal to 2.

11. The display device as claimed in claim 10, wherein one of two adjacent first patterns of the plurality of first patterns is a first electrode, the other one of the two adjacent first patterns of the plurality of first patterns is a second electrode, and the first electrode is different from the second electrode, and wherein one of two adjacent second patterns of the plurality of second patterns is a third electrode, the other one of the two adjacent second patterns of the plurality of second patterns is a fourth electrode, and the third electrode is different from the fourth electrode.

12. The display device as claimed in claim 10, wherein one of the plurality of first patterns is a first electrode, one of the plurality of second patterns is a second electrode, and the first electrode is different from the second electrode.

13. The display device as claimed in claim 10, wherein the first spacing is equal to the second spacing.

14. The display device as claimed in claim 11, wherein the first electrode overlaps with the third electrode, and the second electrode overlaps with the fourth electrode.

15. The display device as claimed in claim 14, wherein the first electrode and the fourth electrode are same electrode, and the second electrode and the third electrode are same electrode.

16. The display device as claimed in claim 15, wherein one of the first electrode and the third electrode is a pixel electrode, and the other one of the first electrode and the third electrode is a common electrode.

17. The display device as claimed in claim 1, wherein the light adjustment unit further includes a first alignment film and a second alignment film, the first alignment film is disposed between the first substrate and the liquid crystal layer, and the second alignment film is disposed between the second substrate and the liquid crystal layer, and wherein the first alignment film has a first rubbing direction, the second alignment film has a second rubbing direction, and the first rubbing direction is parallel to the second rubbing direction.

18. The display device as claimed in claim 1, wherein liquid crystals in the liquid crystal layer adjacent to the first substrate are in horizontal alignment, and liquid crystals in the liquid crystal layer adjacent to the second substrate are in horizontal alignment.

19. The display device as claimed in claim 1, wherein the light adjustment unit further includes a first alignment film disposed between the first substrate and the liquid crystal layer and provided with a first rubbing direction, one of the plurality of first patterns has a length direction, and there is an angle between the first rubbing direction and the length direction, where the angle is between 80^{o} and 100^{o} or between 0^{o} and 10^{o}.

20. The display device as claimed in claim 1, wherein two adjacent first patterns of the plurality of first patterns have a first spacing, and the first spacing is between 6 µm and 12 µm.
